(19) United States
(12) Patent Application Publication
(10) Pub. No.: US 2006/0248567 A1
(43) Pub. Date: Nov. 2, 2006

(54) Signal transmission system and method

(75) Inventors: Earl Vanderhoff, Cranston, RI (US); David Masucci, West Townsend, MA (US); Michael Cardarelli, Windham, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Signal Dynamics, Windham, NH (US)

(21) Appl. No.: 11/413,818

(22) Filed: Apr. 28, 2006

Related U.S. Application Data
(60) Provisional application No. 60/675,812, filed on Apr. 28, 2005.

(51) Int. Cl. H04N 7/173

(52) U.S. Cl. 725/128; 725/121; 725/120; 725/127

(57) ABSTRACT

The present invention relates to a signal transmission system for inserting a communication signal within an upstream and downstream signal. An upstream converter inserts the communication signal within a diplex guard band of the upstream and downstream signal. A downstream converter separates the communication signal within the diplex guard band from the upstream and downstream signal.

### CROSS-REFERENCE TO RELATED APPLICATIONS

The present application claims priority from U.S. provisional patent application, Ser. No. US60/675,812, filed Apr. 28, 2005, by Vanderhoff et al., incorporated by reference herein and for which benefit of the priority date is hereby claimed.

### TECHNICAL FIELD OF THE INVENTION

The present invention relates to communication signals and more particularly, to inserting a communication signal within a band gap.

### BACKGROUND

A significant percentage of Multiple Dwelling Unit managers (MDU's—apartments, single building condominiums, and cooperatives, etc.) desire the ability to allow residents to monitor lobby video in conjunction with entrance intercoms or doorbells. Being able to instantly view whoever is requesting access provides residents with an additional layer of security and greater peace of mind. In fact, state and local regulations often require MDU facilities to provide access monitoring for residents.

Most housing authorities, however, do not have the finances to run the new wiring required for such a system in existing buildings. Where possible, many use existing Master Antenna (MATV) systems, often with less than optimal results. MATV systems, popular before cable television became ubiquitous, are generally decades old, not well maintained, poorly connected in ‘daisy chain’ patterns, un-terminated at nearly every port, and constructed with relatively low-grade materials. The resultant video from such a system is, more often than not, extremely poor. Power frequency (60 Hz) harmonics and interference from fluorescent lighting can produce rolling “hum bars” or shifting diagonal lines in the picture. Low signal levels create “grainy” images. The picture can even tear or scramble when multiple residents attempt to view the lobby video simultaneously.

Often MDU managers attempt to convince their local Cable Operator to replace a normal subscriber channel with lobby video using a “strip and insert” system. This solution provides the residents with exceptional video quality and extremely easy viewing of lobby activity, simply by selecting the appropriate channel on their television or cable converter.

There may be many drawbacks to such a strip and insert system however, which in many cases prevent their use. Strip and insert systems typically incur approximately 6 dB insertion loss throughout the spectrum, with additional 3 dB signal degradation on adjacent channels. Strip and insert systems may also require the affected building to be end-of-line in the cable distribution system and to have a high degree of RF isolation from the remaining plant in either upstream or downstream, to prevent affecting the programming of subscribers not resident in the affected building. The additional signal strength, high isolation, and end-of-line requirements may mean that re-engineering and rebuilding the surrounding cable distribution plant is often required to regain this inherent signal loss.

For these reasons, cable operators generally disallow strip and insert systems for small MDU's. Even if allowed by the cable operator, strip and insert systems may typically take months to survey, engineer and install. The systems are often prohibitively expensive for smaller MDU's. The channel deletion filters required in such systems may have extremely steep loss curves to prevent excessive signal degradation on adjacent video channels, which cannot be achieved with tunable-style filters. They therefore are fixed in frequency and may need to be replaced at every installed building within an operator's footprint should the channel line-up change. Strip and insert systems may also require every resident who wishes to view lobby video to subscribe to a specific cable provider.

Lower-cost digital Set Top Boxes (STB), which are becoming increasingly popular with cable operators, may be incapable of tuning standard analog-modulated channels. These converters cannot display strip and insert video, generally disallowing the resident from viewing the inserted lobby video from their primary television.

### SUMMARY

The present invention is a novel device, system, and method of communication signal transmission. An exemplary embodiment, according to the present invention, inserts a communication signal within an upstream and downstream signal. The system has an upstream converter for inserting the communication signal within a diplex guard band of the upstream and downstream signal. A downstream converter receives the communication signal within the diplex guard band.

Embodiments may include one or more of the following. The upstream and downstream signal may be a standard cable television signal according to the National Television Standards Committee (NTSC). The communication signal may be between about 40 and about 54 megahertz. The communication signal may be a video signal. The downstream converter may insert a second communication signal and the upstream converter may receive the second communication signal. The second signal may be an audio signal or a command signal. A broadband amplifier may amplify the upstream and downstream signal.

It is important to note that the present invention is not intended to be limited to a device, system, or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a block diagram of a broadband amplifier.

FIG. 2 is a frequency spectrum of a cable television signal.

FIG. 3 is a block diagram of an exemplary embodiment of the system when used with a cable subscriber using a cable converter.

FIG. 4 is a block diagram of an exemplary embodiment of the system when used with a cable-ready subscriber.

FIG. 5 is a block diagram of an exemplary embodiment of the system when used with a non-subscriber.

FIG. 6 is a block diagram of an exemplary embodiment of a standard CATV five-tap cascade between two-way distribution amplifiers.

FIGS. 7A-C are signal levels at test points of the exemplary embodiment block diagram of FIG. 6.

FIG. 8 is a block diagram of an exemplary embodiment of a worst-case (highest level) occurrence of RF in the Cable Television (CATV) distribution plant in the upstream direction.

FIGS. 9A-C are signal levels at test points of the exemplary embodiment block diagram of FIG. 8.

FIG. 10 is a block diagram of an exemplary embodiment of a worst-case occurrence of communication signal RF in an adjacent, upstream CATV subscriber drop.

FIG. 11A is a signal level at a test point of the exemplary embodiment block diagram of FIG. 10.

FIG. 12 is a block diagram of an exemplary embodiment of the insertion point moved to the upstream tap.

FIGS. 13A-B are signal levels at test points of the exemplary embodiment block diagram of FIG. 12.

FIG. 14 is a block diagram of an exemplary embodiment of the worst-case (highest level) of communication signal felt at both the downstream distribution amplifier and successive CATV subscribing drop.

FIGS. 15A-D are signal levels at test points of the exemplary embodiment block diagram of FIG. 14.

FIG. 16 is a mathematical model and study based on Scientific Atlanta® SAT MM taps.

FIG. 17 is a block diagram of the downstream converter according to an exemplary embodiment of the invention.

FIGS. 18A-D are schematic diagrams of exemplary setups of the downstream converter.

### DETAILED DESCRIPTION

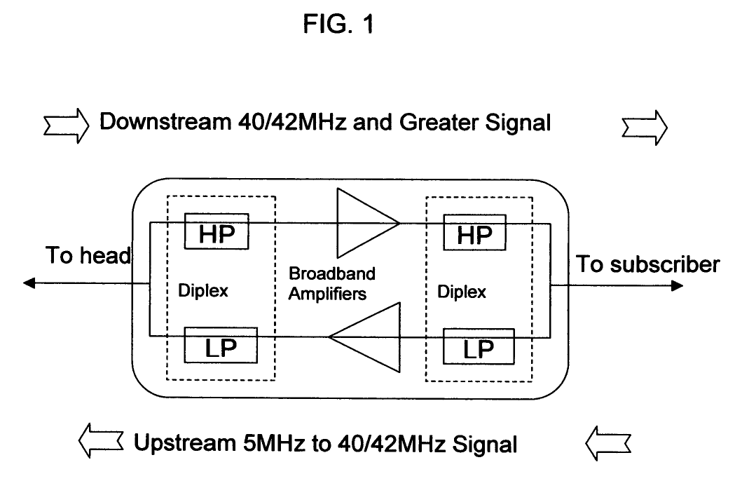

Modern cable systems provide interactive services, such as Internet access (HSD), telephony, VOD, and IPG's, all requiring feedback, or other information from the subscriber, back to the head end. To achieve this path within the confines of a single coaxial cable, cable operators have been forced to divide the total available spectral bandwidth into upstream and downstream frequency bands. This is accomplished through the use of diplex filtering. Referring to FIG. 1, a diplex filter is essentially a high-pass filter connected in parallel with a low-pass filter, with filter values selected such that there is no frequency intercept point. This results in a guard band of unused frequencies existing between the two bands (high-pass and low-pass) that is significantly attenuated by both filters. Without the diplex filters, it may be impractical to amplify the RF signal on the coaxial while maintaining the two-way (upstream and downstream) nature of interactive services. Amplifiers may be required if the distribution plant is to provide service beyond a mere several hundred feet.

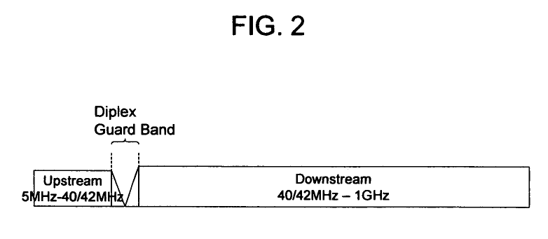

In the United States, upstream frequencies are typically about 5 MHz to 40 MHz or 42 MHz, with downstream frequencies beginning about 52 MHz or 54 MHz and spanning the entire upper pass-band of the distribution active and passive devices (750 MHz to 1 GHz at this time). In each case, the guard band is considered to be about 12 MHz wide. Refer to FIGS. 1 and 2.

The use of diplex filters, in conjunction with two-way amplifiers, allows the cable service provider to offer interactive, services across a single coaxial line, while continuing to pass through several amplifiers. The unintended result, however, is a 12 MHz band of frequencies, which will not pass through even a single cable television distribution amplifier, and is therefore unusable to the cable operator.

These frequencies encompass another standard, NTSC intermediate frequency (IF). The NTSC standard defines an IF frequency set, wherein the AM-modulated video luminance carrier is centered at 45.75 MHz, with chrominance and FM audio signals 3.58 MHz and 4.5 MHz below the video carrier respectively (spectrally inverted in relation to standard television channels, where chrominance and audio are above the carrier by the same margins). If the IF is surface acoustic wave (SAW) filtered, as is the case with any professional-grade video modulator, there is essentially no upper vestigial sideband to the video carrier, and the entire channel signal resides between 41 MHz and 46 MHz; luminance, chrominance, and audio.

The IF standard allows for mass-produced, inexpensive circuits that are readily available for manufacturing equipment that can receive video, audio and/or audio-frequency data, within the spectral confines of the United States' cable television diplex guard, or “stop” band. Another standard in play is the FCC-designated Land Mobile Frequency band between 47 MHz and 49.6 MHz. These frequencies are most often associated with unlicensed consumer equipment, such as walkie-talkies, baby monitors, and radio frequency audio headsets. Within this standard, multiple separate channels of audio or data can be transmitted without exceeding the boundaries of the cable television stop band.

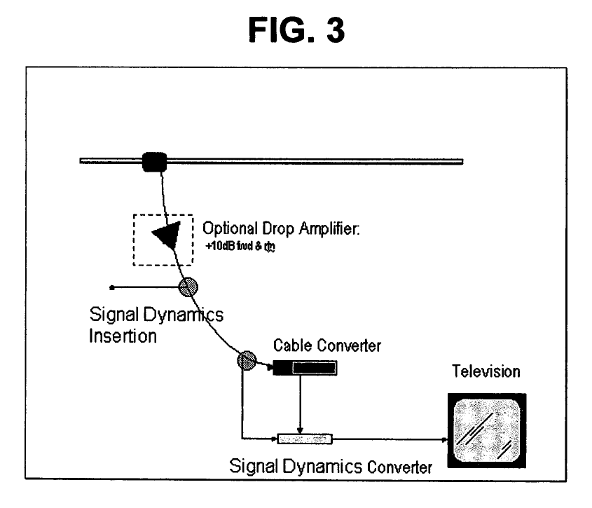

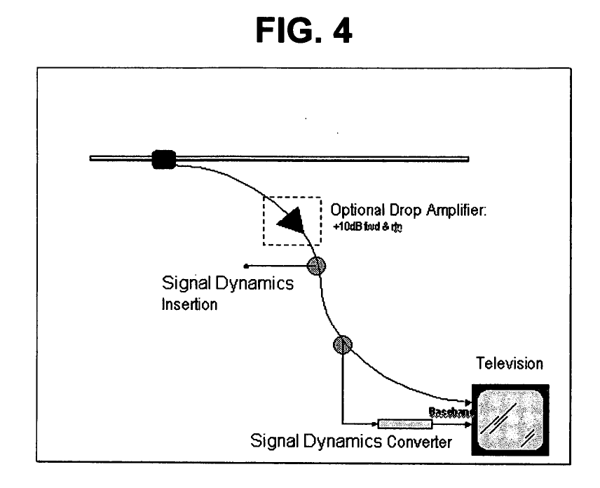

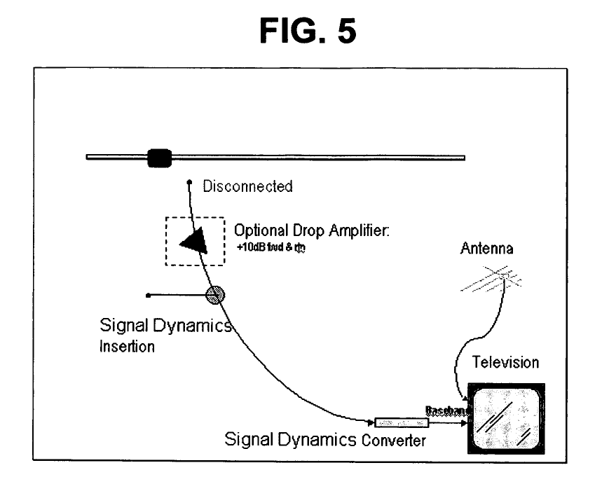

Referring to FIG. 3, an exemplary embodiment of the system is used with cable subscribers using a cable converter. A drop is supplied from the upstream and downstream cable signal. An optional drop amplifier may be used to amplify the upstream and downstream cable signal. An upstream converter inserts a communication signal into the diplex guard band of the upstream and downstream cable signal. The communication signal may be a video signal or other desired signal that needs to be transmitted to the individual unit of the dwelling. A downstream converter separates the communication signal from the upstream and downstream cable signal. If the communication signal is a video signal, the downstream converter may supply the signal to an output that is fed into channels 3 or 4 of a television set. This allows the user to view the video signal from the unit. A cable converter receives the upstream and downstream cable signal which may be unaffected by the insertion of the communication signal. A user may utilize both the cable television signal and the communication signal without interfering with the performance of either signal. The system may also be used with cable-ready subscribers as shown in FIG. 4. The system may also be used with non-subscribers as shown in FIG. 5.

These are the elements employed in the creation of devices and services that can be carried without synergy by any United States cable television coaxial as well as other communication devices worldwide. While at first glance this might seem to violate the lower edge of the guard band (in the case of diplex filters cut for upstream frequency bandwidths to 42 MHz), additional isolation at these frequencies can be achieved through the use of directional couplers.

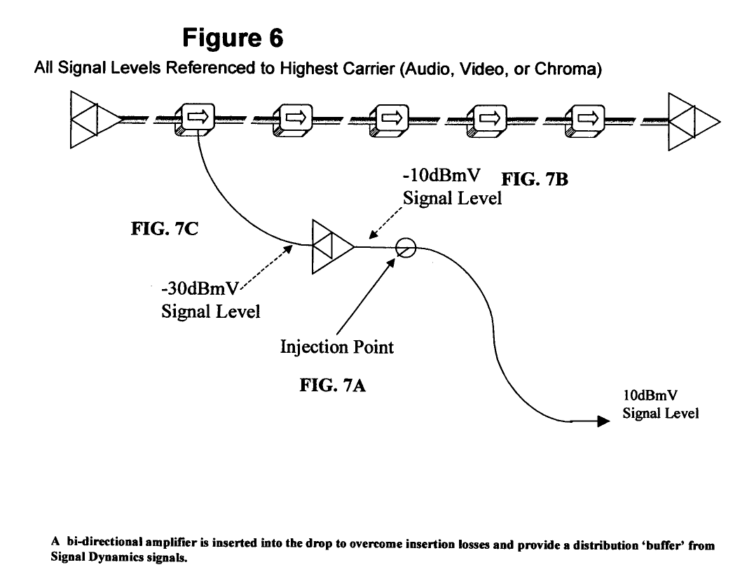

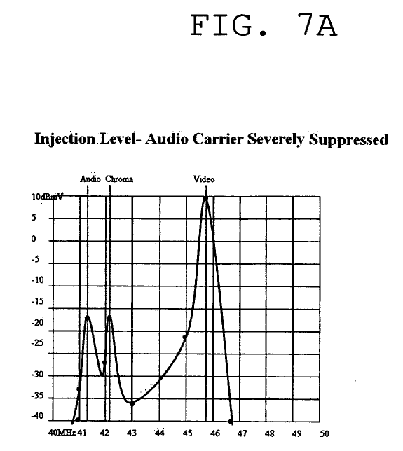

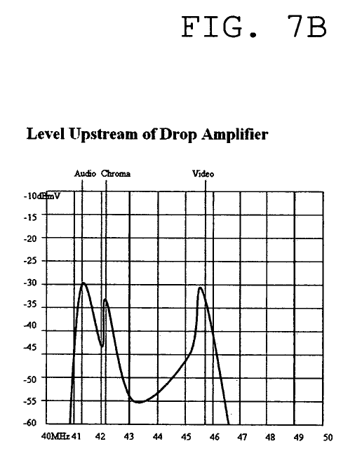

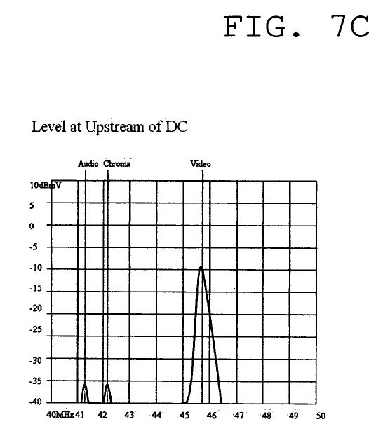

Referring to FIG. 6, a standard CATV five-tap cascade between two-way distribution amplifiers is shown. A single subscriber drop is depicted with a bi-directional amplifier and directional coupler added for insertion of the entrance video and audio RF. RF levels are indicated at the injection point, upstream of the directional coupler, and upstream of the bi-directional drop amplifier (refer to the appropriate expanded graph views in FIG. 7A-C for further detail).

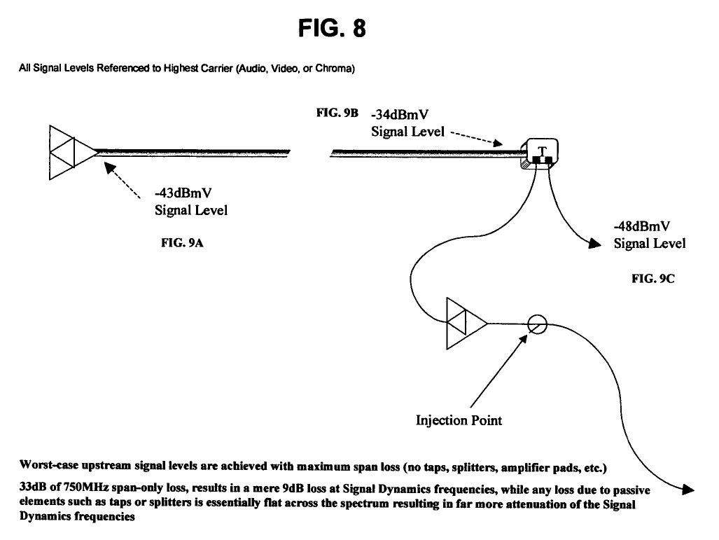

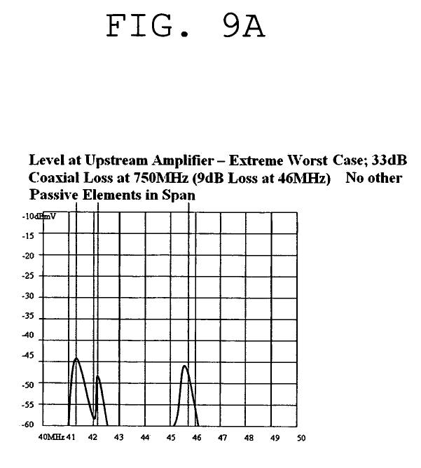

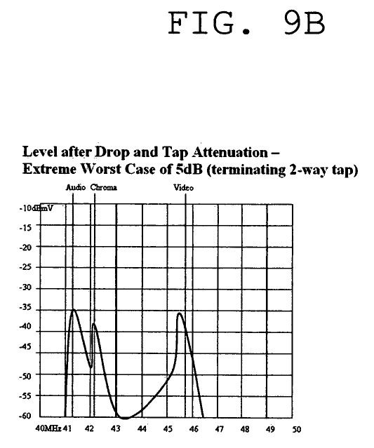

Referring to FIG. 8, a worst-case (highest level) occurrence of RF in the Cable Television (CATV) distribution plant in the upstream direction is shown. In this particular depiction, there is only one tap in the span (that portion of CATV distribution plant between amplifiers), situated at the furthest end of a lengthy section of cable. All CATV and communication signal RF losses in this span, other than from this single tap, are due to attenuation in the coaxial. As one can see, 33 dB of span-only loss at the CATV frequency of 750 MHz affords only 9 dB of loss at the significantly lower frequency of 45.75 MHz video carrier. The tap value indicated is of a 4 dB, 2-way terminating tap, which provides the least attenuation of any RF power-dividing device in the CATV distribution inventory.

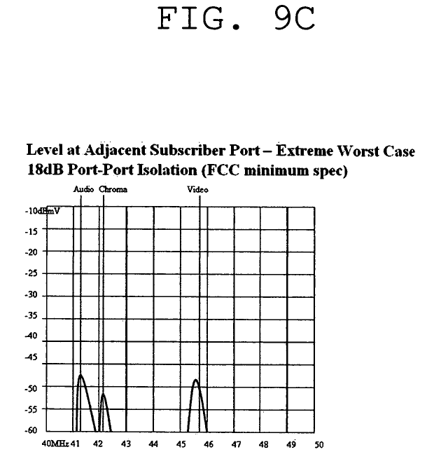

Any additional taps between the communication signal-injected drop and the upstream CATV distribution amplifier would incur an essentially flat loss for both CATV and communication signals, while reducing the maximum cable distance that the cable signal could travel through prior to amplification. Thus flat loss would be gained across both RF bands, at the sacrifice of the more heavily weighted CATV loss of coaxial, significantly decreasing the total attenuation of the Signal Dynamics signal at the upstream amplifier. Signal Dynamics RF levels are indicated at all points of interest (refer to the appropriate expanded graph views in FIGS. 9A-C for further detail).

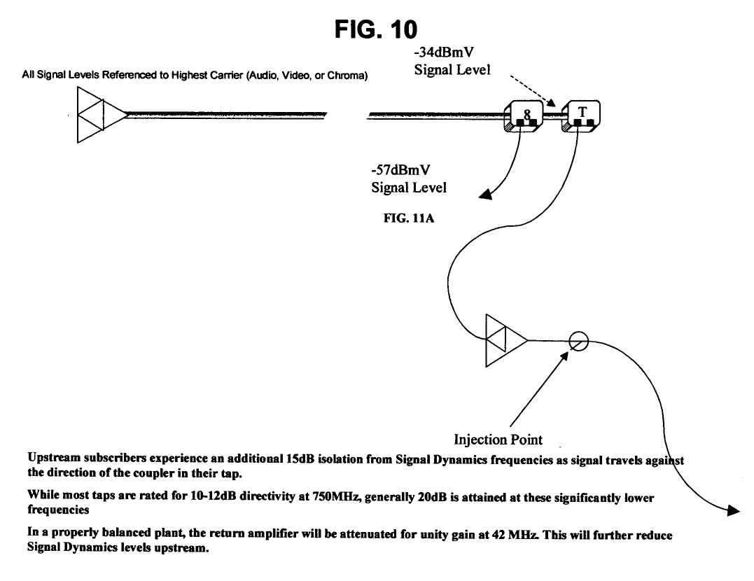

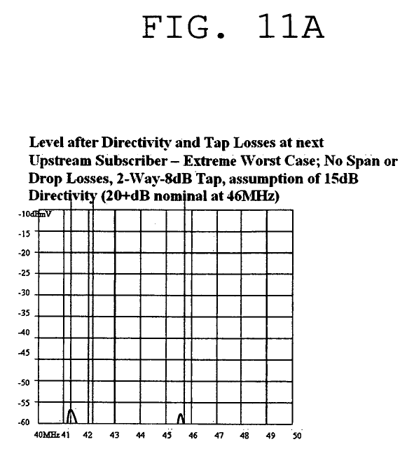

Referring to FIG. 10, this example describes the worst-case occurrence of communication signal RF in an adjacent, upstream CATV subscriber drop. Once again the communication signal RF is injected in the drop of a 2-way terminating tap, providing the absolute least attenuation into the CATV distribution. The adjacent upstream tap is a 2-way, 8 dB type, also chosen to present worst-case (least) attenuation of signal (refer to the appropriate expanded graph views in FIG. 11A for further detail).

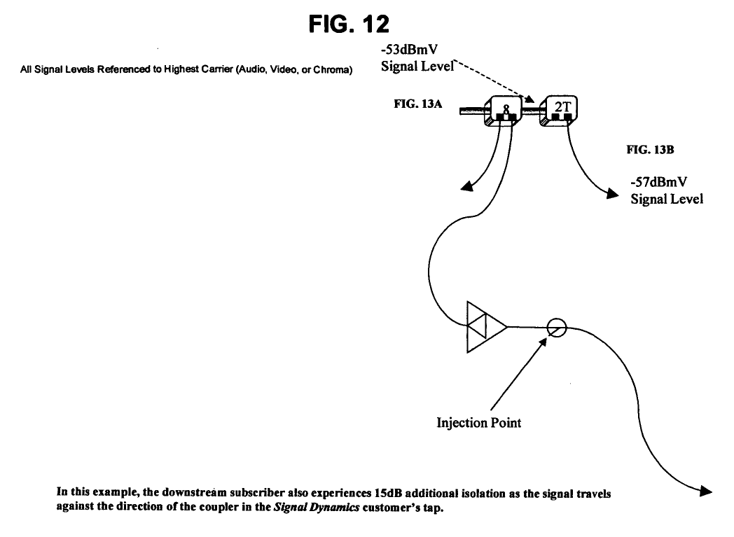

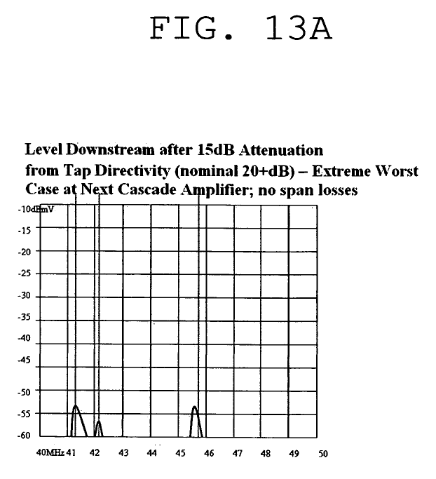

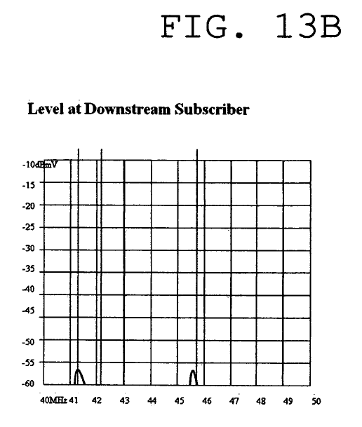

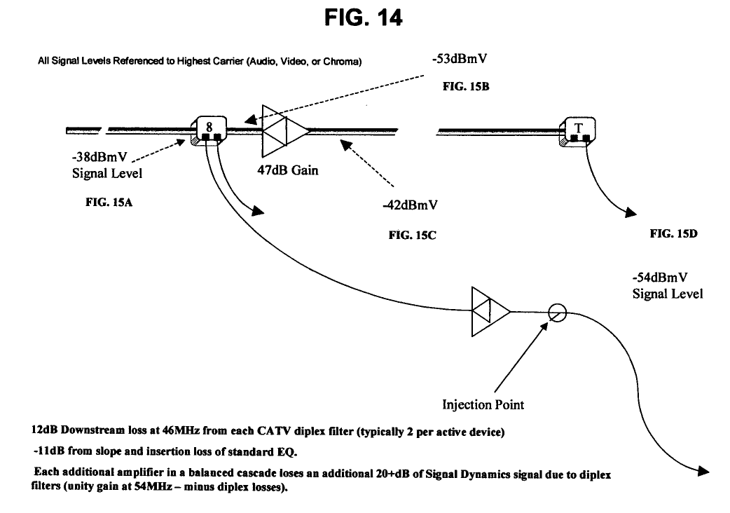

Referring to FIG. 12, the architecture from the previous figure is preserved (2-way 8 dB tap feeding into a 2-way 4 dB terminating tap), but the insertion point has been moved to the upstream tap. This presents the most extreme example of the communication signal occurrence in a downstream subscriber drop (refer to the appropriate expanded graph views in FIGS. 13A-B for further detail).

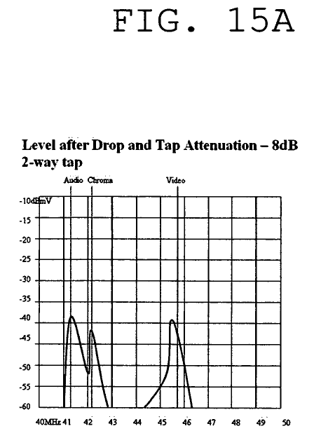

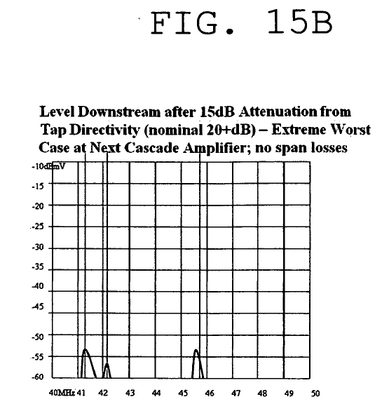

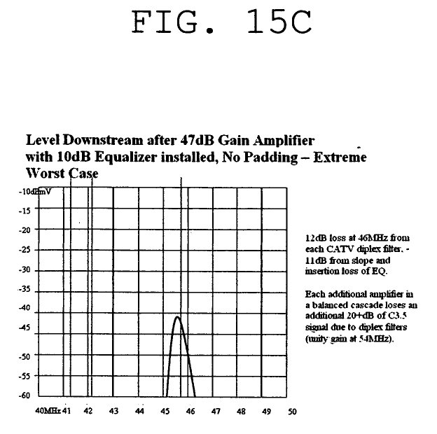

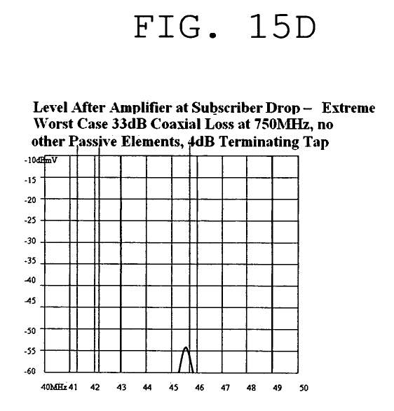

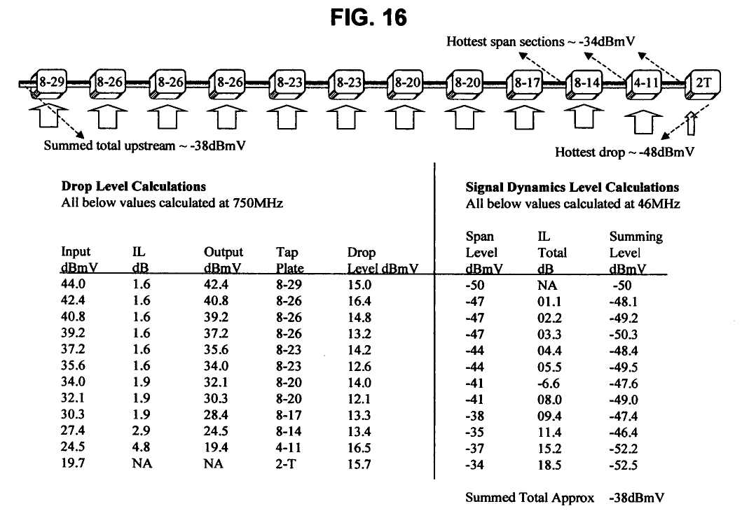

Referring to FIG. 14, the worst-case (highest level) of communication signal felt at both the downstream distribution amplifier and successive CATV subscribing drop is presented. The tap value for communication signal insertion is a 2-way, 8dB variety, which is the least attenuating tap that can be placed without termination. Notice that the tap downstream of the amplifier is again at the furthest distance from the amplifier, and that all losses in that span are cable related (refer to the appropriate expanded graph views in FIGS. 16A-D for further detail).

Referring to FIG. 16, a mathematical study based on Scientific Atlanta® SAT MM taps (values used are as specified by Scientific Atlanta®) is shown. The model assumes an 86-tap span, idealized with no cable losses (all RF attenuation is provided by tap insertion and drop loss). The communication signal injection is placed in all but the last drop of the last tap (the 2-way terminating (‘2T’) tap at the furthest right).

Input RF levels, insertion losses, and drop levels for the CATV signal are calculated on the left; the communication signal span levels (the level of the communication signal delivered to the span from the injected drop, in the upstream direction), total insertion losses (added from furthest downstream to furthest upstream), and summing levels (span level plus total span insertion loss), are calculated on the right. Finally, all summing levels are computed together for the Summed Total of approximately −38 dBmV. This represents an extreme high level of the communication signal possible in any CATV distribution or drop. Calculations in the downstream direction may necessarily assume additional 15 dB directivity from the subscriber tap, and may therefore result in a summed total of approximately −53 dBmV.

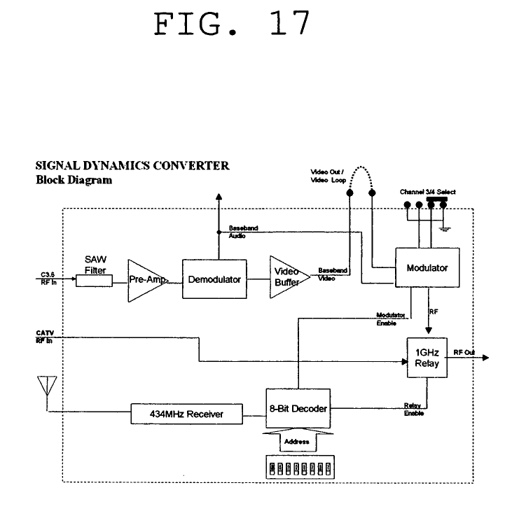

Referring to FIG. 17, the communication signal enters the converter and passes through an input conditioning SAW filter and 10 dB preamplifier. Video and audio are demodulated. The audio signal is split between a channel 3 or 4 modulator and an RCA-style output jack. The video signal is first buffered and then travels to an RCA-style video output loop. Video and audio are always available from these ports regardless of converter state (on/off). This allows the resident to use his existing video/RF television remote control and even picture-in-picture (PIP) functions if available. CATV RF is routed through a 1 GHz relay to the converter RF output. Upon receipt of a valid coded RF signal, the converter turns ‘On’. At this time the channel 3/4 modulator and GHz relay are energized, replacing the CATV RF at the output with Signal Dynamics RF. At no time does the converter produce RF while the customer is viewing CATV. This is an exemplary design of the converter for illustrative purposes. Other designs may be used and are within the scope of the invention.

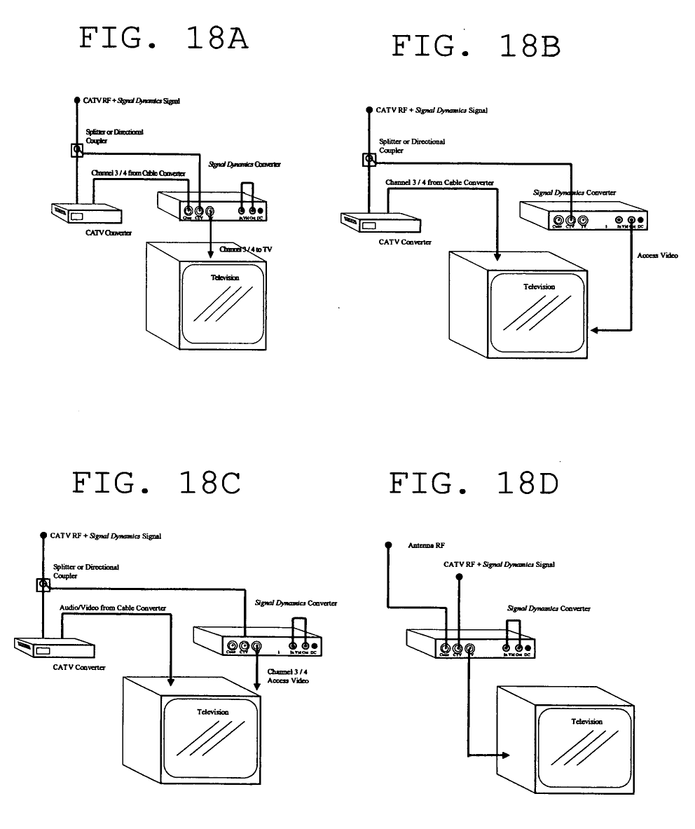

Referring to FIG. 18A, a standard setup of the cable converter's channel 3 or 4 output is routed through the Signal Dynamics converter. Regardless of what channel the viewer might be viewing, a single button press on the Signal Dynamics remote control will replace television programming with Signal Dynamics video. Pressing the button a second time returns the television to the previously viewed program.

Referring to FIG. 18B, TV remote control setup first option uses existing cable/television remote control. This configuration allows the communication video signal to be selected from the existing television remote control by switching between video and antenna or cable inputs. There is no need for a separate remote control. This exemplary setup requires the television to have a video input. This exemplary setup may also be used with, PIP televisions for dual displays. Referring to FIG. 18C, a TV remote control setup second option uses existing cable/television remote control and is similar to the first option, but with outputs reversed.

Referring to FIG. 18D, master antenna or “rabbit ears” configuration may be used if there is no cable converter and the television lacks an available video input. The setup may require two steps to select the communication signal. First, using the TV remote control, tune the television to channel 3, then press the large button on the converter remote. One can return to normal television programming by pressing the button again on the converter remote, then selecting the desired channel on the television remote control.

The converter provides an affordable cable television “private channel” for deployment in the cable drop without interfering with any current or potential future CATV service. Employing frequencies only within the unused stop-band between CATV upstream and downstream spectrums, (40-52 MHz), the communication signal inserts a ‘Point of Presence’ video channel into the residential or MDU drop, without requiring insertion loss to cable television signals in either direction. As these frequencies are not tunable by existing televisions or cable converters, intelligence is required at the television to convert the signal to either video or Standard channel 3 or 4 RF (61.25 MHz or 67.25 MHz video carrier, respectively). This may be achieved with a simple and inexpensive converter.

The converter may be much smaller than traditional cable television converters, and may be remote-controlled from a single button using a hand-held, coded-RF transmitter rather than infrared signaling such as employed by traditional consumer video appliance remote controls. These features allow the converter to be installed discretely behind a television or entertainment center, against a wall, or even behind a wall or crawl space if desired.

The technique provides ample room for more than one analog video channel. Duplex audio and addressable control signals can be provided to, for example, a lobby intercom or access control services. The audio path may be leveraged for data transmission, for example, remote selection of multiple cameras, Pan/Tilt/Zoom controls, Local Video on Demand (LVOD) signaling, or other features.

A method, system, and architecture may provide sending and receiving video and audio services, for the purpose of monitoring apartment or residential lobby or main access video, from individual unit television sets. This system may work in conjunction with the installed cable television coaxial and third-party audio intercom devices to provide residents with a simple and easy way of viewing any intended visitor, prior to allowing access.

The converter enables a high-quality audio/video channel, receivable from any NTSC television or consumer-grade video equipment, transmitted across and localized to the cable television “drop” (that portion of the cable distribution dedicated to providing service to a single subscriber, and including cable, splitters, amplifiers, etc.). Additional applications include, but are not limited to:

Hotel/Motel private video channels such as movie or adult video services

School private video channels for educational purposes

“Bulletin Board” channels for information dissemination in schools, MDU's, office buildings, hospitals, etc.

As well as other modes of communication

Another embodiment may include the addition of an RF transmitter and addressable circuit in the apartment converter, and the creation of a main entrance call device. The transmitter may broadcast within the land mobile frequencies of about 47-49.6 MHz. In conjunction with the main entrance call device, this will allow the residents addressable, two-way audio communications with the lobby, including access control (electronic strike, magnetic lock, etc.), via DTMF or other digital audio-frequency signaling, enabling a complete audio/video intercom and access-control solution over the cable television coaxial.

The equipment may function as an addressable public alert or announcement system. The equipment may allow the resident to use this audio frequency path to transmit telemetry for camera selection, alternate access monitoring, pan/tilt/zoom controls, infra-red controls, and/or localized VOD handshaking (movie selection, fast-forward, rewind, pause, etc.). A remotely configurable NTSC character generator may be provided for overlaying the video content with both “bulletin-board” services and/or visible alerts for the hearing impaired, while maintaining the intercom and access-control facility of the architecture.

Further embodiments may provide multiple audio receive and transmit channels within the converter, using the land mobile frequencies or other frequencies, for the purpose of intercom “station-to-station” communications, and/or to facilitate a “concierge” channel. Another embodiment may utilize the addition of a telephone line emulation circuit and DTMF decoder within the converter, allowing the resident to use a standard DTMF-enabled telephone to switch their television to/from viewing main access video, communicate audibly with the intended visitor, and control access. Normal telephone access may not be disabled to employ these features. Another embodiment may include an integrated video monitor. Another embodiment may not incorporate NTSC IF and video transmission, which provides a simple and effective audio and access-control-only intercom device for facilities not wishing to purchase a video solution.

The method, system, device, and architecture deliver color video and audio and/or data to premises' televisions or other standard NTSC video and audio devices, and transmit audio and/or data from premises, over existing cable television coaxial, without interference to, or from, any cable television product coexisting on that cable. Such cable television services may include, but are not limited to: DOCSIS High Speed Data (HSD), circuit switched or IP telephony, QAM-based and NTSC video/audio or QPSK digital music, sweep systems or set top box (STB) telemetry, interactive program guides (IPG's) or other interactive services such as video on demand (VOD) VCR-functionality functionality (ffwd, rewind, pause, etc.), polling, targeted advertising, etc.

A device for reception and demodulation of NTSC IF data, audio, and video signals, and delivery to a standard television or other communications equipment may be direct base-band (video and audio) connection, and/or via EIA channel 3 or 4 (selectable) via a switched RF port. The device may be capable of operation while installed within a cable television drop, in conjunction with cable television signals, and without interference from or to any cable service. Control of the device may be via an 8-bit encoded RF remote control.

An 8-bit, audio-frequency digital addressable circuit, and keyed/addressable RF audio-modulated transceiver may be used to deliver a complete audio/video intercom/access-control solution, utilizing resident televisions, and/or integrated video/audio monitors, and including DTMF or audio frequency digital signaling for access control functions, such as door strike or magnetic lock control, over the existing cable television coaxial.

Additional RF audio or audio-frequency data modulated transceivers may be incorporated as another embodiment of the system. A telephone-emulation circuit and DTMF decoder may be incorporated to allow unit operation from a standard tone-style telephone without affecting telephone service.

An addressable/keyed audio and audio-frequency data transceiver capable of operation within the cable television drop, in conjunction with cable television signals, and without interference from or to any cable operator service, for audio and access-control. A lobby or main entrance call device with and without installed camera. The device may be available for single-family residences and MDU's. In the case of MDU's, this device may be available with both standard ledger and LCD scroll-type library control functions.

The methods, devices and architecture may be used to transmit information signals both upstream and downstream via the guard band. The signal transmission may be designed to limit and/or prevent interference with signals related to the resulting guard band. The system is not limited to the guard band frequencies used by the United States cable industry. The system may be implemented at various guard band frequencies and with a variety of other information signals that may require or result in a guard band. Modifications and substitutions by one of ordinary skill in the art are considered to be within the scope of the present invention.

The invention claimed is:

1. A signal transmission system for inserting a communication signal within an upstream and downstream signal comprising:
a upstream converter for inserting the communication signal within a diplex guard band of the upstream and downstream signal and
a downstream converter for receiving the communication signal within the diplex guard band.

2. The signal transmission system of claim 1, wherein the upstream and downstream signal is a standard cable television signal according to the National Television Standards Committee.

3. The signal transmission system of claim 1, wherein the communication signal is between about 40 and about 54 megahertz.

4. The signal transmission system of claim 1, wherein the communication signal is a video signal.

5. The signal transmission system of claim 1, wherein the downstream converter inserts a second communication signal and the upstream converter receives the second communication signal.

6. The signal transmission system of claim 1, wherein the second signal is an audio signal.

7. The signal transmission system of claim 1, wherein the second signal is a command signal.

8. The signal transmission system of claim 1, further comprising a broadband amplifier for amplifying the upstream and downstream signal.

9. A system for inserting a dwelling video signal specific to a multiple unit dwelling within a cable television signal received by the multiple unit dwelling comprising:
a camera for producing the dwelling video signal;
a dwelling converter for receiving the dwelling video signal and inserting the dwelling video signal within a diplex guard band of the cable television signal and
a unit converter for separating the dwelling video signal from the cable television signal and outputting to a television within a unit of the multiple unit dwelling.

10. The system of claim 9, wherein the cable television signal complies with the standards set by the National Television Standards Committee.

11. The system of claim 9, wherein the dwelling video signal is between about 40 and about 54 megahertz.

12. The system of claim 9, wherein the unit converter inserts an audio signal and the dwelling converter separates the audio signal from the cable television signal.

13. The system of claim 9, wherein the unit converter inserts a door unlock signal and the dwelling converter separates the door unlock signal from the cable television signal and causes a door to the dwelling to unlock.

14. The system of claim 9, wherein the unit converter inserts a camera control signal and the dwelling converter separates the camera control signal from the cable television signal and causes adjustment of the camera based on the camera control signal.

15. A signal transmission method for inserting a communication signal within an upstream and downstream signal comprising:
amplifying the upstream and downstream signal with a broadband amplifier;
inserting the communication signal within a diplex band of the broadband amplifier; and
separating the communication signal within the diplex band from the upstream and downstream signal.
